(19) United States
(12) Patent Application Publication
(10) Pub. No.: US 2016/0116894 A1
(43) Pub. Date: Apr. 28, 2016

(54) CONTROL SYSTEM WITH A NETWORK OF CONTROLLERS USING LINKED CAUSE-AND-EFFECT MATRICES

(71) Applicant: Flow Data, Inc., Grand Junction, CO (US)

(72) Inventors: Paul S. Brennan, Grand Junction, CO (US); Keith Thomson, Grand Junction, CO (US)

(73) Assignee: FLOW DATA, INC., Grand Junction, CO (US)

(21) Appl. No.: 14/526,157

(22) Filed: Oct. 28, 2014

(51) Int. Cl. G05B 19/05

(52) U.S. Cl. CPC G05B 19/056

(57) ABSTRACT

A control system has a master controller having a control program with a primary cause-and-effect matrix defining cause-and-effect relationships between a set of inputs and a set of outputs to control its operation. A number of secondary controllers communicate with the master controller via a network. Each secondary controller has a control program with a secondary cause-and-effect matrix defining cause-and-effect relationships between a set of inputs and a set of outputs to control its operation. Selected inputs/outputs of the cause-and-effect matrices are communicated over the network and linked between the primary and secondary cause-and-effect matrices.

### BACKGROUND OF THE INVENTION

1. Field of the Invention

The present invention relates generally to the field of industrial control systems. More specifically, the present invention discloses a control system for a network of controllers using linked cause-and-effect matrices.

2. Statement of the Problem

Programmable process controllers (e.g., process logic controllers or PLCs) have been used for many years to monitor and control a wide variety of industrial equipment, field devices and instrumentation. The PLC typically includes a programmable computer processor with associated data storage. A control program controls operation of the PLC. Historically, most PLCs have been programmed by Ladder Logic, IEC 61131 compliant methods, or C/C++ compiled applications. But, these methods require specialized personnel with programming knowledge and training.

In addition, an application written with traditional methods requires programming changes when the function of the program is altered. This can be a major issue if the required change needs to occur in the field where a qualified programmer is not available. Most traditionally-programmed systems are designed and programmed to support a defined and finite set of features and operations, and therefore tend to be rigid and constant in their structure.

Control system designers have long used cause-and-effect diagrams in defining and documenting the desired operation of a control system, even prior to the advent of programmable controllers. Early cause-and-effect diagrams were typically drawn on paper as a visual tool to assist the system designer in creating a control system that was then implemented in electrical circuitry, computer hardware and/or software having a desired set of operational control characteristics.

A cause-and-effect diagram typically includes a specified set of inputs or “causes” represented as rows in the diagram, and a specified set of outputs or “effects” represented as columns in the diagram. The matrix of intersections between these rows and columns is used to specify whether the cause associated with that matrix element should result in the operation of the effect associated with that matrix element. For example, a check in the matrix at the intersection of the second row and the third column indicates that the presence of the cause associated with the second row should result in the operation of the effect with the third column of the matrix. In this manner, each effect can be specified to occur as a result of one or more causes, and the presence of any particular cause can result in one or more effects.

An input or “cause” can be defined to occur when a predetermined event, state or condition is detected, such as the operation of fault detection devices, overflow or underflow conditions, the position of switches or shutdown valves, sensor readings and the like. Similarly, the outputs or “effects” used by a cause-and-effect diagram can include a wide variety of desired control responses, such opening or closing valves, turning devices on or off, actuating switches, triggering alarms, etc.

In recent years, the metaphor of a cause-and-effect diagram has been implemented as a programming technique and operational interface in programmable controls, due to the widespread use and familiarity of cause-and-effect diagrams in the industry. For example, U.S. Pat. No. 6,941,261 (Quinn), U.S. Pat. No. 6,369,836 (Larson) and U.S. Pat. No. 6,448,982 (Klapper) show systems that allow a user to generate a cause-and-effect matrix to control operation of a controller. U.S. Pat. No. 6,898,468 (Ott et al.) and U.S. Patent App. Pub. No. 2013/0138227 (Gohr et al.) also including a viewer application so the user can monitor the status and operation of the controller.

### Solution to the Problem

The present invention extends the concept of a cause-and-effect matrix to multiple controllers communicating over a network. Each controller is equipped with a separate cause-and-effect matrix, but selected inputs and outputs of these matrices can be linked across the communications network, so that control commands, events, and data can be propagated over the network of controllers. In particular, the present system can be implemented as a hierarchical structure of controllers, with at least one master controller having a primary cause-and-effect matrix linked to a tree structure of secondary cause-and-effect matrices on secondary controllers.

More narrowly, the present system can also be implemented by sharing “cause” rows across multiple controllers, rather than each controller having an independent cause-and-effect matrix. This effectively allows the secondary cause-and-effect matrices to be reduced to an array of “effects.”

### SUMMARY OF THE INVENTION

This invention provides a control system having a master controller with a control program using a primary cause-and-effect matrix to define cause-and-effect relationships between a set of inputs and a set of outputs to control its operation. A number of secondary controllers communicate with the master controller via a network. Each secondary controller has a control program with a secondary cause-and-effect matrix defining cause-and-effect relationships between a set of inputs and a set of outputs to control its operation. Selected inputs/outputs of the cause-and-effect matrices are communicated over the network and linked between the primary and secondary cause-and-effect matrices. These linkages between the cause-and-effect matrices enable the master controller to control and monitor operation of the secondary controllers and their related sensors and equipment.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a block diagram of a control system with multiple controllers 10, 20a-20c communicating over a network 30.

FIG. 2 is a diagram illustrating an example of a cause-and-effect matrix 40 for controlled operation of a controller.

FIG. 3 is a block diagram showing the various software modules associated with the controllers 10 and 20a-20c.

FIG. 4 is a block diagram showing linked cause-and-effect matrices 12, 22 for the master and secondary controllers.

### DETAILED DESCRIPTION OF THE INVENTION

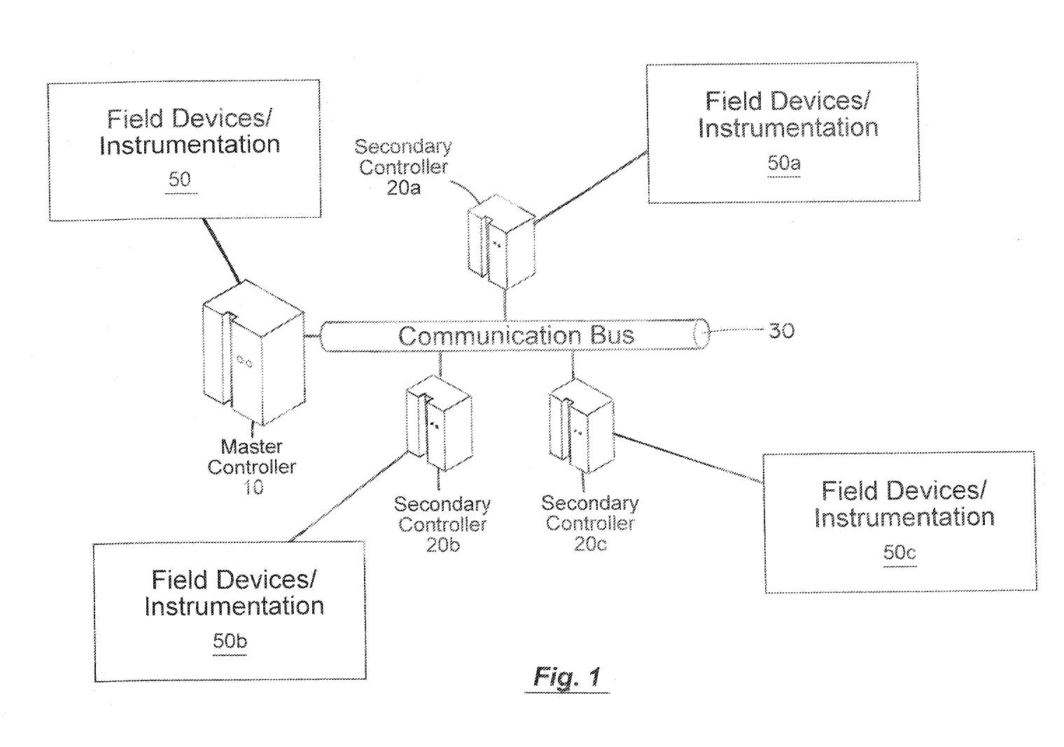

Turning to FIG. 1, a simplified system block diagram is provided showing an example of the hardware that could be used to implement the present invention. Since embodiments of the present invention are not limited to any particular process control environment, for sake of brevity, the simplified process control architecture is described at a high level. In the present example, multiple programmable process controllers 10, 20a, 20b and 20c are coupled in communication with field devices/instrumentation 50, 50a-50c (e.g., well controllers, storage tanks, motors, solenoids, drivers, sensors, actuators, multi variable transmitters and the like—depending upon the context) via a wired or wireless communications network (e.g., a bus using a network communication protocol standard, such as Modbus Plus, Modbus TCP/IP, Modbus RTU, BACnet, DeviceNet, LONWorks and the like) to allow input signals to be received from and commands to be provided to the field devices/instrumentation 50, 50a-50c.

Depending upon the memory, I/O and processing requirements of the industrial automation or process control environment at issue, the controllers 10, 20a-20c can be small, non-modular PLCs (also known as fixed I/O PLCs), such as the MELSEC FX3U compact (available from Mitsubishi Electric) that generally accommodate a smaller number of inputs and outputs in fixed configurations; or a modular/rack type PLC having a chassis or bases/racks that allow installation of multiple I/O modules, and typically accommodate more complex applications. Two non-limiting examples of such modular type PLCs include the Modicon Quantum rack/backplane system (available from Schneider Electric), which can be configured with the desired number of Modicon Quantum Unity stand-alone processor modules, discrete input modules, analog input modules and hot standby modules; and the PLC-5/1771 system (available from Rockwell Automation, Inc.), which can also be configured with the desired number of PLC-5 processor modules, 1771 communication modules, 1771 I/O modules and a 1771 power supply in a 1771 chassis platform.

In the embodiment shown in FIG. 1, one of the controllers is designated as the master controller 10 and the remaining controllers are secondary controllers 20a-20c. Here again, the controllers 10, 20a-20c communicate over a wired or wireless communications network as previous described. For example, an Ethernet bus 30 or a serial bus using a standard communications protocol could be used. The embodiment in FIG. 1 shows an embodiment with a hierarchical control structure having one master controller 10 and multiple secondary controllers 20a-20c. It should be understood that this could be extended in any tree structure of controllers. In addition, the present invention could be extended to non-hierarchical control systems and control systems with multiple master controllers.

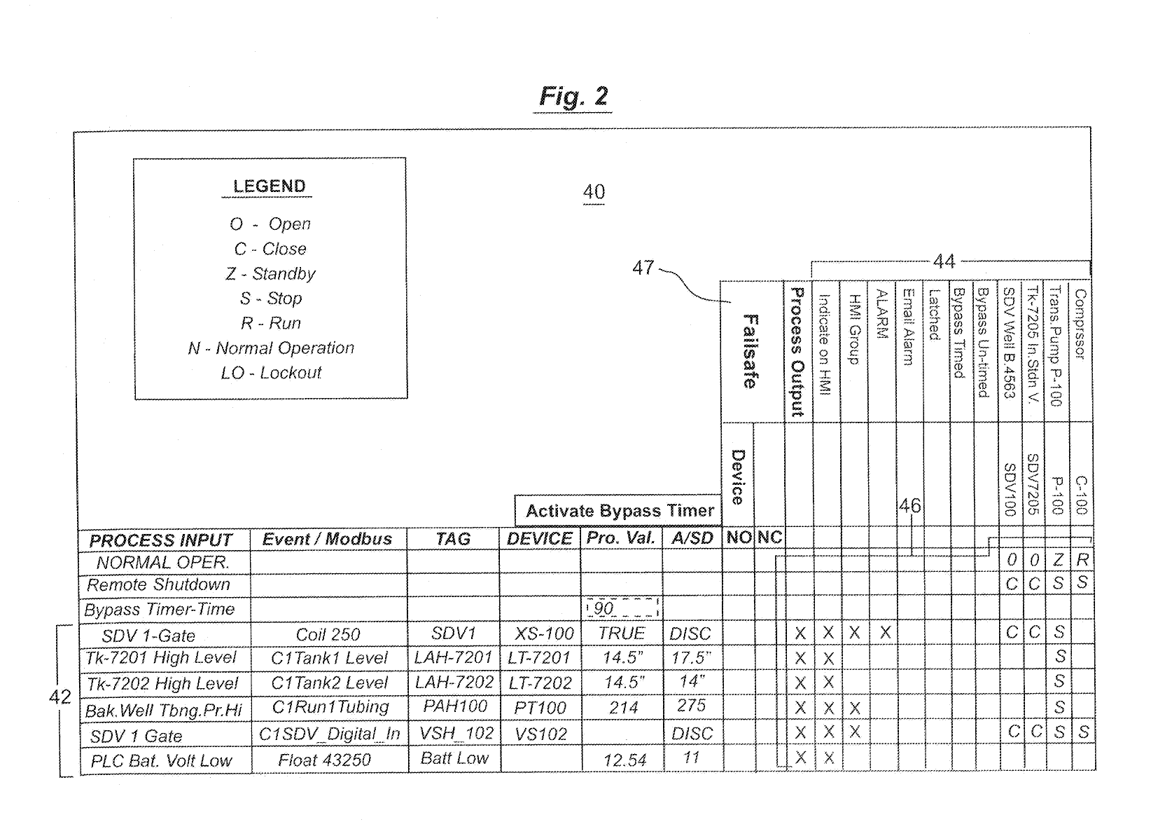

FIG. 2 is an example of a cause-and-effect matrix 40 for controlled operation of a controller 10, 20a-20c. As previously discussed, a cause-and-effect matrix 40 has a specified set of inputs or “causes” 42 represented as rows in the diagram, and a specified set of outputs or “effects” 44 represented as columns in the diagram. The matrix elements 46 at the intersections between these rows and columns are used to specify whether the cause associated with that matrix element should result in the operation of the effect associated with that matrix element. In addition, a variety of actions and flags can be assigned to each matrix element 40. The cause-and-effect matrix 40 can be stored as an XML (eXtensible Markup Language) file, although other data formats could be employed, such as a comma-separated value (CSV) file or a text file.

Each controller 10, 20a-20c is provided with a control program that reads the file containing its cause-and-effect matrix from storage at start up and uses it to build corresponding logic states governing subsequent operation of the controller as previously discussed. The implementation can be event driven and/or directly driven by the Modbus data state.

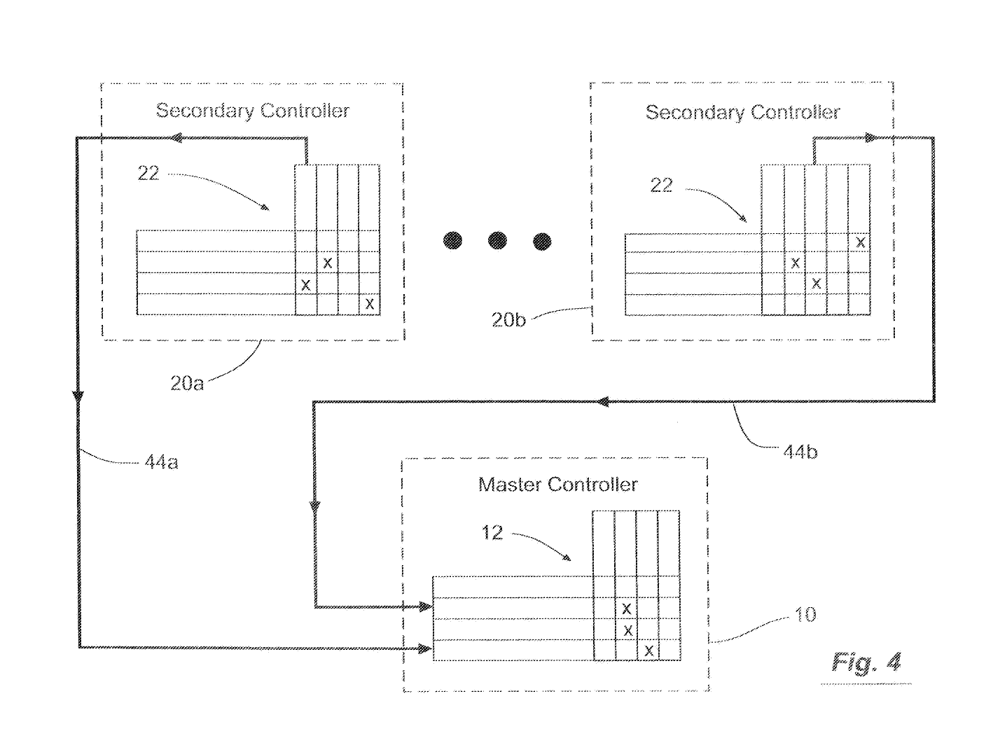

The control program in the present system supports distributed cause-and-effect logic across multiple controllers 10, 20a-20c. As shown in FIG. 4, selected outputs (or “effects”) 44a, 44b of a cause-and-effect matrix 22 on one controller 20a, 20b can be communicated across a communications network to serve as inputs (or “causes”) in a cause-and-effect matrix 12 on another controller 10. In this embodiment of the present invention shown in FIG. 4, the primary cause-and-effect matrix 12 on the master controller 10 is linked to the secondary cause-and-effect matrices 22 on a number of secondary controllers 20a, 20b, etc. In other words, selected outputs of the secondary cause-and-effect matrices 22 can be linked to serve as inputs of the primary cause-and-effect matrix 12.

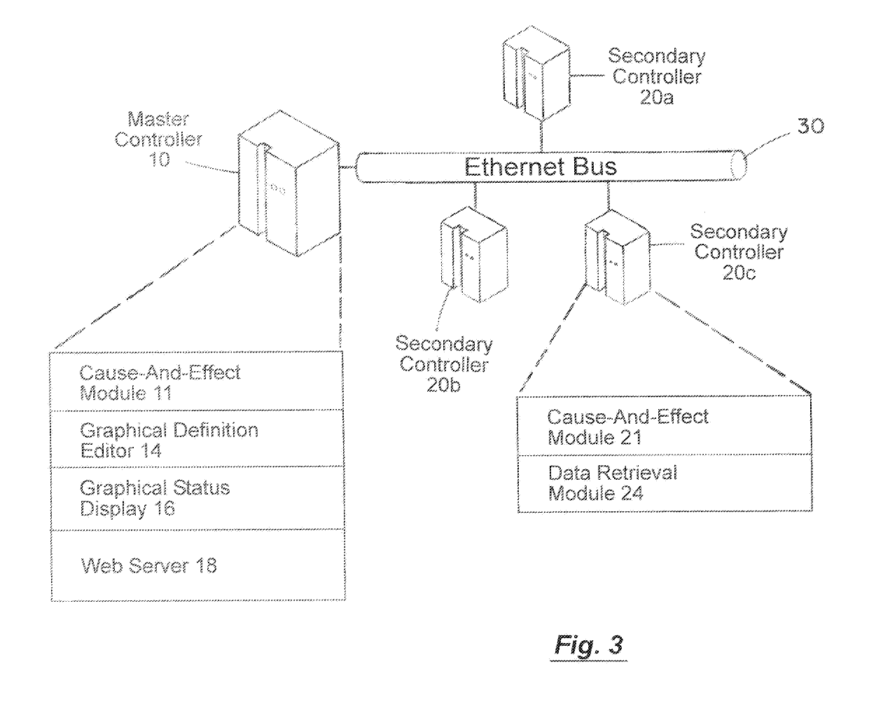

The control program of each controller 10, 20a, 20c includes cause-and-effect module 11, 21 as shown in FIG. 3 that interpret and provide control functionality based on the cause-and-effect matrix for that controller. In the embodiment of the present invention shown in FIGS. 3 and 4, the cause-and-effect module 11 for the master controller 10 serves as the coordinator module for the entire control system. It includes data representing both the inputs and outputs of the master controller's cause-and-effect matrix, as well as the linked inputs pulled from other secondary controllers 20a, 20b. It also contains additional data that applies to the entire chart, including registers for outputting statuses and registers for values that will be changed online.

The secondary controllers 20a, 20b linked to the primary cause-and-effect matrix have a cause-and-effect module 21. Here again, the secondary cause-and-effect module 21 interprets and provides control functionality based on the secondary cause-and-effect matrix 22 for the secondary controller 20a, 20b. It includes data representing both the inputs and outputs of the secondary cause-and-effect matrix, and also has a set of linked outputs that are triggered by polling from the master controller 10.

The degree of linkage between cause-and-effect matrices on different controllers, and the allocation of decision-making among the controllers are largely matters of discretion in system design. In one embodiment of the present invention, the cause rows in the matrices are shared across all controllers, rather than each controller having an independent cause-and-effect matrix. Each controller has a separate set of effect columns, each of which can be viewed as an array. The cause-and-effect decisions are all essentially made by the master controller. Each secondary controller receives updates of the state of the rows in its cause-and-effect matrix based on the primary cause-and-effect matrix running on the master controller (e.g., row input values and row status registers are communicated between controllers), and takes the “effect” actions specified by its set of effect columns. The master controller can also read input states from the secondary controllers so it can make these decisions using its primary cause-and-effect matrix.

This distributed control scheme is supported by data retrieval modules 24 that transfer data between the controllers. In the hierarchical embodiment shown in FIGS. 3 and 4, the data retrieval modules 24 are used for data acquisition by the master controller 10 to get input values from the secondary controllers 20a, 20b. The master controller 10 fills out a list of events and registers requested from the secondary controllers 20a, 20b. The secondary controllers 20a, 20b then respond by filling out an output block for the master controller 10 to read.

The data retrieval modules 24 also act as watch dogs for communication failures, as well as unknown input status to set “fail safe” logic states in the cause-and-effect logic. The cause-and-effect matrices for the controllers can be provided with an inherent “fail safe” feature built in, which in the event of a communication failure between controllers, causes the outputs 47 of the cause-and-effect matrix to transition to predetermined “fail safe” states. For example, consider the case in which the master controller directly monitors a tank level via a local sensor. The primary cause-and-effect matrix has an corresponding input row for this tank level, and a resulting output to shut off the well associated with this tank if a predetermined level is exceeded. The output is controlled via a valve output to a secondary controller located near the well. During normal operation, the primary cause-and-effect matrix sends the second cause-and-effect matrix the appropriate status for the well valve on a regular basis. However, if a communications failure is detected (i.e., the cause-and-effect messages fail to arrive for predetermined amount of time), the secondary controller is now not sure what state its outputs should be in (e.g., the tank could be full, but the secondary controller doesn't know it). To prevent this, it transitions into a communication fault mode with predetermined “fail safe” states. In the previous example, the “fail safe” state for the well valve control would be “closed for fail safe” to close the valve. This “fail safe” scenario would avert the danger of the well continuing to produce into a full tank, which could other cause an environmental or safety issue.

The controllers 10, 20a-20c can also be equipped with additional software modules as shown in FIG. 3. For example, the controller can be provided with a graphical definition editor 14 for creating and modifying a cause-and-effect matrix. This presents the matrix in a form very similar to a traditional paper cause-and-effect chart, and the user to graphically configure the rows, columns and matrix elements of the cause-and-effect matrix. The resulting matrix data can be stored on the controller as an XML file, or in CSV or text format for subsequent use by the control program, as previously discussed. Alternatively, the matrix data could be stored in any of a variety of formats, including binary, register and database formats.

The controllers 10, 20a-20c can also be equipped with a software module for graphical status display 16 on a local display device or via a web interface (e.g., via a browser). This status display module 16 provides a similar graphical representation of the cause-and-effect matrix, with relevant rows and columns highlighted to let the use know what conditions exist in the chart. The status display module 16 can also display other system information to enable the user to readily understand the overall system status and any alarm conditions.

As shown in FIG. 3, a web server module 18 can be included to provide a web-based interface (e.g., a browser) to the controller and its other software modules. The web server module 18 enables, for example, physically connected or wirelessly connected configuration devices to access pre-programmed web pages designed to display and allow editing of parameters of cause-and-effect matrix and other controller parameters using standard internet/web protocols. This feature provides a web-based interface for configuration, and eliminates the need for an external PC-based configuration program, together with all of the maintenance and version control issues associated with external PC applications. The configuration tool also supports imports and exports of configuration data in XML format.

The following is more detailed discussion of the preferred embodiment of the XML and Modbus data structures in the present invention. The overall controller structure specifies a Modbus communications channel for each controller, as well as an RTU address, and associates it to a controller number for use elsewhere throughout the remainder the system configuration.

Each cause-and-effect matrix 12, 22 is defined in terms of its rows and columns (i.e., inputs and outputs). A row (or input) is defined by a row name, data source, data transformation, delay, and flags. The row name is a text field. The data source can be either: (1) a Modbus data communication; or (2) an “event,” as supported for example by the PADPro control management system marketed by Flow Data, Inc. of Grand Junction, Colo. A data source can also specify a Modbus address or an event on a different controller. If the data source is Modbus, it will specify the data type, byte/word order, and address. If the data source is an event, it will specify an event identifier, such as an event number and run/tank address in PADPro. The data transformation parameter can include an operation, such as equal, not equal, greater than, less than, greater than or equal, less than or equal for numeric values, and direct or inverted for Boolean values. It can also include a set point stored in the Modbus register block (e.g., as a 32 bit floating point number). The delay parameter allows a true value to be held for a set period of time before taking effect in the cause-and-effect chart. The flags parameter include an alarm flag and a “send email” flag to determine the handling of these rows. A bypass flag can also be included in Modbus.

A column (or output) in a cause-and-effect matrix includes a column name and a data destination. Here again, the data destination can be either: (1) Modbus data communication; or (2) an event. If the data destination is Modbus, it will specify the data type, byte/word order, and address. If the data destination is an event, it will specify an event identifier, such as an event number and run/tank address in PADPro. There is also a default and alarm state for each column that is used when the system is manually put into bypass or alarm states.

Finally, an interaction list defines how each column will respond to given rows in a cause-and-effect matrix 40. For a cause-and-effect matrix 40 as a whole this is provided by the matrix elements 46, as shown in FIG. 2. However, for each individual column 44 in a matrix, only a one-dimensional list of interaction elements is required, corresponding to one column in the matrix. In one embodiment of the present invention, these interactions can have the following values: Direct (True=Active), Inverse (False=Active) and Set/Reset. If any interaction with a row is active, then the column output is true. Rows with no interactions defined are ignored. In another embodiment, the interactions can have additional values such as: O—open, C—close, Z—standby, S—stop, R—run, N—normal operation, LO—lockout. It should be understood that other sets of permissible interactions could employed. The current status of each column/output is stored in a Modbus array.

A number of global settings are shared across all of the controllers in the control system. A unique identification number is assigned to each cause-and-effect matrix and used to link matrices together across controllers in the XML file. There is also a block of Modbus addresses used to store a FIFO queue of alarm conditions. There are Modbus addresses for enabling bypass times, and for setting the bypass timer length, and displaying the remaining time on the bypass timer. There is an array of flags indicating the status of all rows, including the corresponding output, process variable, delay time remaining, and intermediate status.

The following is a discussion of the startup procedure and normal operating procedures. On startup, each controller 10, 20a-20c opens the XML file containing its cause-and-effort matrix 12,22, and the data structures discussed above are created for each controller 10, 20a-20c. In particular, an array of rows and an array of columns are created, as described above to match the size of the configuration. A hash map can be created for the rows/inputs in the cause-and-effect matrix for quickly determining if any row is triggered by an event that arrives. A linked list is attached for each column/output based on the interactions defined for that column with each row in the cause-and-effect matrix. Polling maps are also created and scheduled for transmission to the secondary controllers.

During normal operation, each controller 10, 20a-20c operates in accordance with the logic states defined by its cause-and-effect matrix 40. With regard to field devices/instrumentation 50, 50a-50c directly associated with a particular controller 10, 20a-20c, these devices are polled by the controller using the Modbus communications protocol, for example. When a response (e.g., an event) is received in response from a device, the controller determines which rows/inputs 42 are triggered. This can be done using a hash map to identify the relevant rows or by iterating through all of the rows in the cause-and-effect matrix. For example, if the row cites a Modbus register, the register is read and placed in the process variable location of that row. Any applicable data transformation rules for the row are applied to the process variable to determine a true or false status for the row. Any delay, bypass, or alarm statuses for the rows are also updated. If the row is labeled as an alarm, it is added to the alarm queue. An email alarm can also be sent, if designated.

The control program for the controller 10, 20a-20c then iterates through the columns 44 in the cause-and-effect matrix. For each column, the control program traverses the linked list of interaction elements looking at any Direct or Inverse interaction specified for each row, and also looking at the final true/false status of that row. If a Direct interaction is specified for the row and the row has a true status, then the result of the column is true as an output. If an Inverse interaction is specified and the row has a false status, then the result of the column is true. Rows with no interactions defined in the linked list for that column are ignored. In addition, the set/reset flags are updated as appropriate.

After evaluation of the rows and columns of the cause-and-effect matrix in response to an event, the control program directs the controller to take the actions specified by the true/false status of each of the columns. For example, this may entail opening or closing a valve, or starting or stopping a motor, as its applies to field devices or instrumentation directly associated with that controller.

In the present invention, selected inputs/outputs of the cause-and-effect matrices on different controllers are communicated and linked between multiple controllers. In the embodiment shown in FIG. 4, one or more of the column outputs of the secondary cause-and-effect matrices 22 on secondary controllers 20a-20c may be communicated over the communications network 30 to serve as inputs to the rows in the primary cause-and-effect matrix 12 on the master controller 10. In the preferred embodiment of the present invention, the master controller 10 iteratively polls the secondary controllers 20a-20c over the communications network 30 using the Modbus communications protocol, for example, to get required input values for the primary cause-and-effect matrix 12 from the other controllers 20a-20c. In particular, the control program of the master controller 10 sends a list of events and registers requested to each relevant secondary controller 20a-20c, and the data retrieval module 24 of that secondary controller 20a-20c fills out an output block for the master controller 10 to read over the communications network 30.

When this response is received from a secondary controller 20a-20c, the master controller determines which rows/inputs are triggered in the primary cause-and-effect matrix 12. This can be done using a hash map to identify the relevant rows or by iterating through all of the rows in the primary cause-and-effect matrix 12. For example, if the row cites a Modbus register, the register is read and placed in the process variable location of that row in the primary cause-and-effect matrix. Any applicable data transformation rules for the row are applied to the process variable to determine a true or false status for the row. Any delay, bypass, or alarm statuses for the rows are also updated. If the row is labeled as an alarm, it is added to the alarm queue. An email alarm can also be sent, if designated.

### TERMINOLOGY

The terms “connected”, “coupled”, “linked” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The phrase “controller” generally refers to a digital computer that is optimized for control tasks (e.g., integrated input/output (I/O) for sampling/monitoring signals from external devices, including, but not limited to measurement and control devices, and providing command signals to the external devices) and/or an industrial environment (e.g., designed to withstand vibrations, temperature, humidity and noise and comply with specific electromagnetic interference (EMI), radio-frequency interference (RFI) and/or electromagnetic compatibility (EMC) requirements). A remote terminal unit (RTU) and a programmable logic controller (PLC) are two examples of controllers. Programmable process controllers are typically capable of running a compiled program.

The term “responsive” includes completely or partially responsive.

The term “graphical user interface” or “GUI” generally includes any type of processor-driven interface or display presenting an operator with control options or information in graphical format (e.g., icons), and allowing the operator to dynamically interact with the display by means of a touch screen, touch pad, mouse, joystick, or similar input devices.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A control system for equipment comprising:
a master controller having a control program with a master cause-and-effect matrix defining cause-and-effect relationships between a set of inputs and a set of outputs based on the configuration of equipment associated with the master controller, to thereby control operation of the master controller; and
at least one secondary controller in communication with the master controller via a network, said secondary controller having a control program with a secondary cause-and-effect matrix defining cause-and-effect relationships between a set of inputs and a set of outputs based on the configuration of equipment associated with the secondary controller, to thereby control operation of the secondary controller;
wherein selected inputs/outputs of the cause-and-effect matrices are communicated over the network and linked between the master and secondary cause-and-effect matrices.

2. The control system of claim 1 wherein selected outputs of the secondary cause-and-effect matrix are linked to inputs of the master cause-and-effect matrix.

3. The control system of claim 1 further comprising a graphical definition editor enabling a user to define a cause-and-effect matrix for a controller.

4. The control system of claim 1 wherein the cause-and-effect matrix is stored as an XML (eXtensible Markup Language) file that is interpreted by the control program of a controller.

5. The control system of claim 1 wherein at least one of the inputs for the master cause-and-effect matrix comprise data communicated over the network from the secondary controller.

6. The control system of claim 1 wherein at least one of the inputs for the master cause-and-effect matrix comprise an event defined by an output of the secondary cause-and-effect matrix and communicated over the network to the master controller.

7. The control system of claim 1 wherein at least one of the controllers further comprise a graphical user interface enabling a user to view a representation of the cause-and-effect matrix indicating the current status of the controller.

8. The control system of claim 7 wherein the graphical user interface is browser-based.

9. A control system comprising:
a master controller having a control program with a master cause-and-effect matrix defining cause-and-effect relationships between a set of inputs and a set of outputs to thereby control operation of the master controller; and
at least one secondary controller in communication with the master controller via a network, said secondary controller having a control program with a secondary cause-and-effect matrix defining cause-and-effect relationships between a set of inputs and a set of outputs to thereby control operation of the secondary controller;
wherein selected outputs of the secondary cause-and-effect matrix are communicated over the network and linked to inputs of the master cause-and-effect matrix.

10. A method of controlling equipment comprising:
providing a plurality of controllers for controlling equipment, said controllers communicating via a network;
creating a cause-and-effect matrix for each controller, wherein the cause-and-effect matrix defines cause-and-effect relationships between a set of inputs and a set of outputs to control operation of the controller based on the configuration of equipment associated with the controller, and with selected inputs/outputs of the cause-and-effect matrices being linked between selected controllers; and
operating each controller according to its cause-and-effect matrix to control the equipment, with the selected inputs/outputs being communicated between the cause-and-effect matrices of the selected controllers via the network.

11. The method of claim 10 wherein the controllers have a hierarchical relationship with a master controller and at least one secondary controller, and wherein selected outputs of the cause-and-effect matrices of the secondary controllers are linked to inputs of the cause-and-effect matrix of the master controller.

12. The control system of claim 11 wherein at least one of the inputs for the cause-and-effect matrix of the master controller comprise data communicated over the network from a secondary controller.

13. The control system of claim 11 wherein at least one of the inputs for the cause-and-effect matrix of the master controller comprise an event defined by an output of the cause-and-effect matrix of a secondary controller and communicated over the network to the master controller.

14. The method of claim 10 further comprising providing a graphical user interface allowing a user to view a representation of the cause-and-effect matrix for a controller to indicate the current status of the controller.

15. The control system of claim 14 wherein the graphical user interface is browser-based.

16. The method of claim 10 further comprising providing the controller with a control program to interpret the controller's cause-and-effect matrix and communicate with other controllers via the network.
